(19) United States
(12) Patent Application Publication
(10) Pub. No.: US 2022/0110478 A1
(43) Pub. Date: Apr. 14, 2022

(54) SANDWICH MAKER

(71) Applicant: PRESIDENT CHAIN STORE CORP., Taipei City (TW)

(72) Inventors: Yu-Chieh Wu, Taipei City (TW); I-Ting Chang, Taipei City (TW)

(21) Appl. No.: 17/105,724

(22) Filed: Nov. 27, 2020

(30) Foreign Application Priority Data
Oct. 14, 2020 (TW) 109213470

(51) Int. Cl. A47J 37/06

(52) U.S. Cl. CPC A47J 37/0611; A47J 37/0629

(57) ABSTRACT

A sandwich maker includes a body, a tray, and a hot-pressing mechanism. The body has an inlet, where the tray may enter or exit the body through the inlet. The hot-pressing mechanism includes a hot-pressing upper mold and a hot-pressing lower mold, and the hot-pressing upper mold and the hot-pressing lower mold may be relatively closed toward a side of the tray or reset toward an opposite direction. The sandwich maker further includes a first driving mechanism and a material receiving structure. Ingredients of a sandwich are placed on the tray, the tray can enter or exit the body, and a mold is relatively closed by driving the hot-pressing mechanism through the first driving mechanism to perform automatic two-sided hot pressing on the ingredients of the sandwich, so that both sides of the ingredients of sandwich are heated evenly.

### CROSS-REFERENCE TO RELATED APPLICATION

This non-provisional application claims priority under 35 U.S.C. § 119(a) to Patent Application No. 109213470 filed in Taiwan, R.O.C. on Oct. 14, 2020, the entire contents of which are hereby incorporated by reference.

### BACKGROUND

### Technical Field

The present invention relates to the technical field of food processing devices, and in particular, to a hot sandwich press.

### Related Art

With the improvement of living standards and the acceleration of the pace of life, people attach greater importance to nutrition and convenience of breakfast. A sandwich maker is a fast and convenient breakfast baking appliance and can be used to bake ingredients of a sandwich, to facilitate making of the sandwich, bringing convenience to people's life. An existing sandwich maker is mostly in a manual hot-pressing processing mode. Specifically, a heating upper mold and a heating lower mold thereof are hinged. After a user puts the ingredients of the sandwich into the heating lower mold, the user needs to turn over the heating upper mold manually so as to heat the ingredients of the sandwich. Because the heating upper mold has a certain weight, it is more laborious for the user to turn over and cover the heating upper mold. In addition, when the ingredients of the sandwich with a large thickness is pressed hot, because the heating upper mold and the heating lower mold are hinged at the ends, an angle is easily formed between the heating upper mold after turned over and the heating lower mold, resulting in uneven heating of the ingredients of the sandwich during hot pressing of the ingredients of the sandwich, and causing a non-ideal product experience effect. In addition, when the user puts the ingredients of the sandwich into the heating lower mold or takes the ingredients of the sandwich out of the heating lower mold, the ingredients of the sandwich are prone to contact with the heating lower mold, causing residues of the ingredients of the sandwich to fall on a periphery of the machine, causing a cleaning trouble to the user.

### SUMMARY

The present invention is intended to provide a sandwich maker that is convenient for a user to operate, heat ingredients evenly, and is hygienic in use in order overcome shortcomings of the prior art.

In order to achieve the foregoing objectives, the present invention adopts the following technical solutions:

A sandwich maker is provided, including a body, a tray, and a hot-pressing mechanism. A front side of the body has an inlet in communication with an inside of the body. The tray enters or exits the body through the inlet. The hot-pressing mechanism includes a hot-pressing upper mold and a hot-pressing lower mold respectively located on an upper side and a lower side of the tray. The hot-pressing upper mold and the hot-pressing lower mold are relatively closed toward one side of the tray or reset toward an opposite direction. The sandwich maker further includes a first driving mechanism and a material receiving structure. The first driving mechanism is configured to drive the hot-pressing upper mold and the hot-pressing lower mold to be relatively closed or separated. The material receiving structure is disposed on a front side of the body and located on a lower side of the tray, and is configured to catch residues of ingredients falling from the tray when the tray is in an exit state.

Compared to the prior art, for the sandwich maker of the present invention, the ingredients of the sandwich is placed on the tray, the tray can enter the body or exit the body, and a mold is relatively closed by driving the hot-pressing mechanism through the first driving mechanism to perform automatic two-sided hot pressing on the ingredients of the sandwich, so that the ingredients of the sandwich is heated evenly on both sides, achieving a simple structure and good heating effect. There is no need fora user to manually operate the hot-pressing upper mold, facilitating use of the user. In addition, the material receiving structure is disposed on a front side of the body to prevent residues of the ingredients on the tray from falling on a workbench surface, so that the user is not required to clean the workbench surface, facilitating cleaning of the residues by the user and achieving hygiene in use of the product.

Further, the material receiving structure is a material receiving tray connected to a front side of the body. The material receiving solution has a simple structure and is convenient for cleaning.

Further, the sandwich maker further includes a residue receiving tray disposed in the body and located on a lower side of the hot-pressing mechanism. A guide opening is disposed on the body. The residue receiving tray enters the body or exits through the guide opening to an outer side of the body. Through such arrangement, the residue receiving tray is separately disassembled from the body, effectively preventing residues of ingredients from leaving in the body, facilitating cleaning up of the residues by the user and hygiene in use of the product, and helping the user take out the material receiving tray separately on the front side of the body.

Further, the guide opening is disposed on the front side of the body and on the upper side of the material receiving tray. Through such arrangement, the user may pull out or install the residue receiving tray within a visible line of sight, facilitating operation of the user.

Further, a pull-out structure facilitating pulling out of the residue receiving tray to the outer side of the body is disposed on an outer side of the residue receiving tray. The pull-out structure is a handle or a hook hole connected by using a tool. Through such arrangement, the user may pull out the residual receiving tray and clean the residues in the residue receiving tray conveniently.

Further, the tray is made of a thermally conductive material. Through such arrangement, the hot-pressing lower mold can transfer heat to the ingredients of the sandwich through the tray to ensure a heating effect of the ingredients.

Further, two inlets are provided. Two trays are provided corresponding to the two inlets. Through such arrangement, the user may simultaneously perform hot pressing on a plurality of ingredients of the sandwich conveniently.

As another driving method of the tray, a second driving mechanism is further included. The second driving mechanism is configured to drive the tray into the body or exit through the inlet to the outer side of the body. Two inlets are provided. Two trays are disposed corresponding to the two inlets. Two second driving mechanisms are provided correspondingly. Through such arrangement, the tray may automatically enter the body or exit to the outer side of the body, so that the sandwich maker can realize fully automated work, reducing the labor of the user and facilitating use.

Further, the first driving mechanism includes an upper driving mechanism and a lower driving mechanism. The upper driving mechanism is configured to drive the hot-pressing upper mold, and the lower driving mechanism is configured to drive the hot-pressing lower mold. The upper driving mechanism and the lower driving mechanism are one kind of screw transmission mechanisms, pneumatic push rods, or electric push rods. Through such arrangement, the first driving mechanism has a simple structure, facilitating product manufacturing.

### BRIEF DESCRIPTION OF THE DRAWINGS

FIG. 1 is a schematic diagram of a hot sandwich press;

FIG. 2 is a schematic diagram of an exit state of a residue receiving tray of the hot sandwich press;

FIG. 3 is a schematic diagram of a tray and a hot-pressing mechanism;

FIG. 4 is a schematic diagram of a hot pressing mechanism;

FIG. 5 is a schematic diagram of a tray;

FIG. 6 is a top view of the tray;

FIG. 7 is a cross-sectional view of a tray in an exit state when ingredients of a sandwich are placed in a hot sandwich press;

FIG. 8 is a cross-sectional view of a tray feeding ingredients of the sandwich into the hot sandwich press; and

FIG. 9 is a cross-sectional view of hot pressing by a sandwich maker on ingredients of the sandwich.

### DETAILED DESCRIPTION

Technical solutions of the present invention are illustrated in combination with drawings.

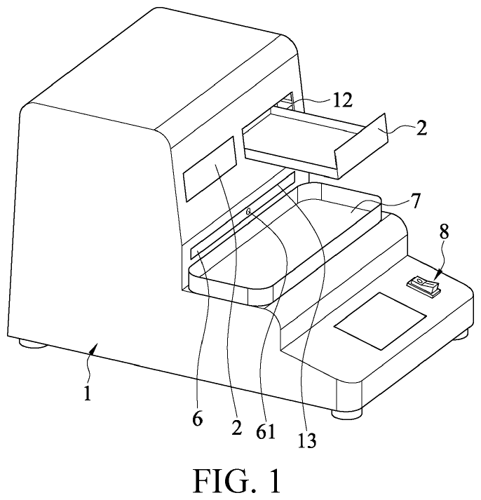

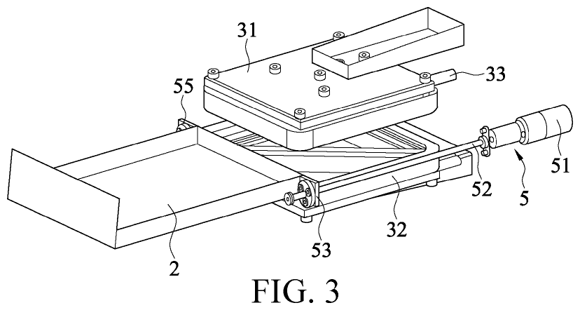

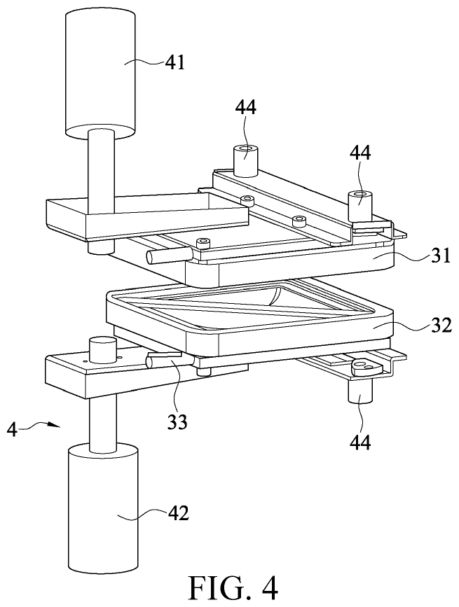

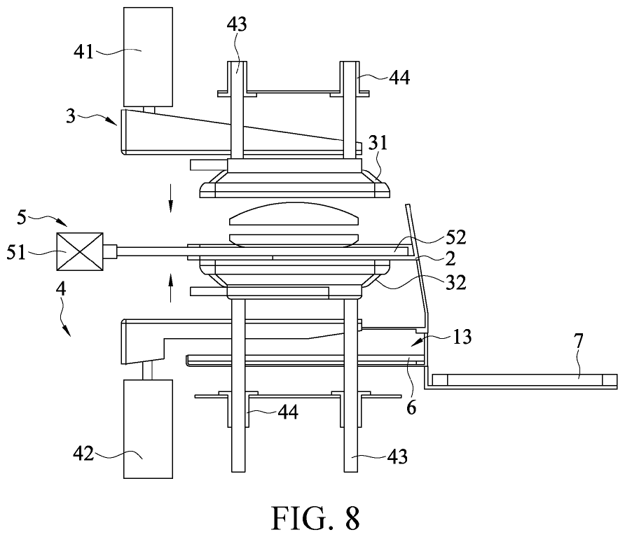

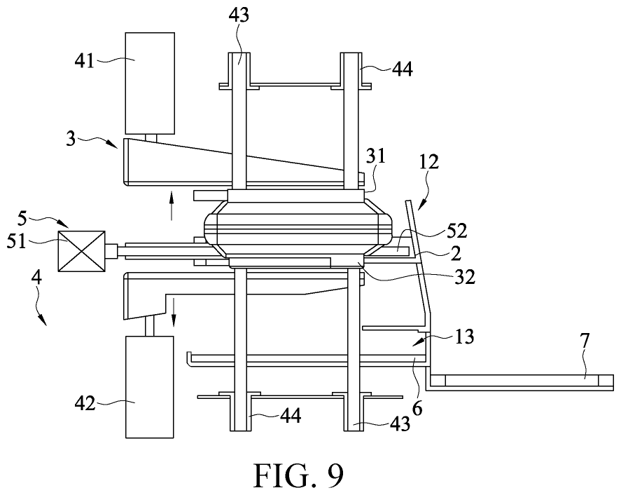

Referring to FIG. 1 to FIG. 9, a sandwich maker of the present invention includes: a body 1, a tray 2, and a hot-pressing mechanism 3. A front side of the body 1 has an inlet 12 in communication with an inside of the body. The tray 2 can enter or exit the body 1 through the inlet 12. The hot-pressing mechanism 3 includes a hot-pressing upper mold 31 and a hot-pressing lower mold 32 respectively located on upper side and a lower side of the tray 2. A heating element 33, such as a heating tube, is disposed on each of the hot-pressing upper mold 31 and the hot-pressing lower mold 32. The hot-pressing mold 31 and the hot-pressing lower mold 32 can be closed toward one side of the tray 2 relatively or reset to an opposite direction. The sandwich maker further includes a first driving mechanism 4 and a material receiving structure. The first driving mechanism 4 is configured to drive the hot-pressing upper mold 31 and the hot-pressing lower mold 32 to be relatively closed or separated. The material receiving structure is disposed on a front side of the body 1 and located on a lower side of the tray 2, and is configured to catch residues of ingredients falling from the tray 2 when the tray 2 is in an exit state.

Compared to the prior art, the sandwich maker of the present invention catches ingredients of the sandwich on the tray 2, and the tray 2 can enter the body 1 or exit the body 1, and a mold is relatively closed by driving the hot-pressing mechanism 3 through the first driving mechanism 4 to achieve automatic two-sided hot pressing of the ingredients of the sandwich, so that the ingredients of the sandwich is heated evenly on both sides, achieving a simple structure and good heating effect. There is no need for a user to manually operate the hot-pressing upper mold 31, facilitating operation of the user. In addition, the material receiving structure is disposed on a front side of the body 1 to prevent residues of the ingredients on the tray 2 from falling on a workbench surface, so that the user is not required to clean the workbench surface, facilitating cleaning of the residues by a user and achieving hygiene in use of the product.

Referring to FIG. 1, in an embodiment, the material receiving structure is a material receiving tray 7 connected to a front side of the body 1. The material receiving structure has a simple structure and is convenient for cleaning.

Referring to FIG. 1 to FIG. 4, in an embodiment, a residue receiving tray 6 disposed in the body 1 and located on a lower side of the hot-pressing mechanism 3 is further included. A guide opening 13 is disposed on the body 1, and the guide opening 13 is disposed on a front side of the body 1 and is located on an upper side of the material receiving tray 7. The residue receiving tray 6 can enter the body 1 or exit an outer side of the body 1 through the guide opening 13. Through such arrangement, the residue receiving tray 6 is separately disassembled from the body 1, effectively preventing residues of the material from leaving in the body 1, facilitating cleaning up of the residues by the user and use of the product cleanly, and helping the user take out the material receiving tray 6 separately on the front side of the body 1. Moreover, the guide opening 13 is disposed on the upper side of the material receiving tray 7, helping the user pull out or install the residue receiving tray 6 within a visible range of sight, and helping the user operate.

In an embodiment, a pull-out structure facilitating pulling out of the residue receiving tray 6 to the outer side of the body 1 is disposed on an outer side of the residue receiving tray. The pull-out structure is a handle or a hook hole connected by using a tool 61. Through such arrangement, the user may pull out the residual receiving tray 6 and clean the residues in the residue receiving tray 6 conveniently.

In a further embodiment, the tray 2 is made of a thermally conductive material. Through such arrangement, the hot-pressing lower mold 32 can transfer heat to the ingredients of the sandwich through the tray 2 to ensure a heating effect of the ingredients and ensure that the ingredients of the sandwich are heated on both sides.

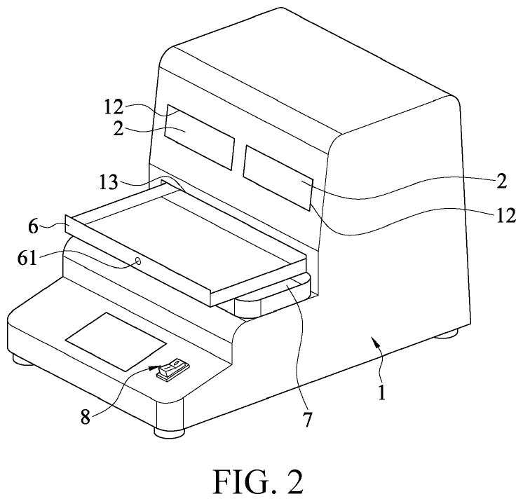

Referring to FIG. 1 and FIG. 2, in an embodiment, two inlets 12 are provided. Two trays 2 are provided corresponding to the two inlets 12. Through such arrangement, the user may simultaneously perform hot pressing on a plurality of ingredients of the sandwich conveniently.

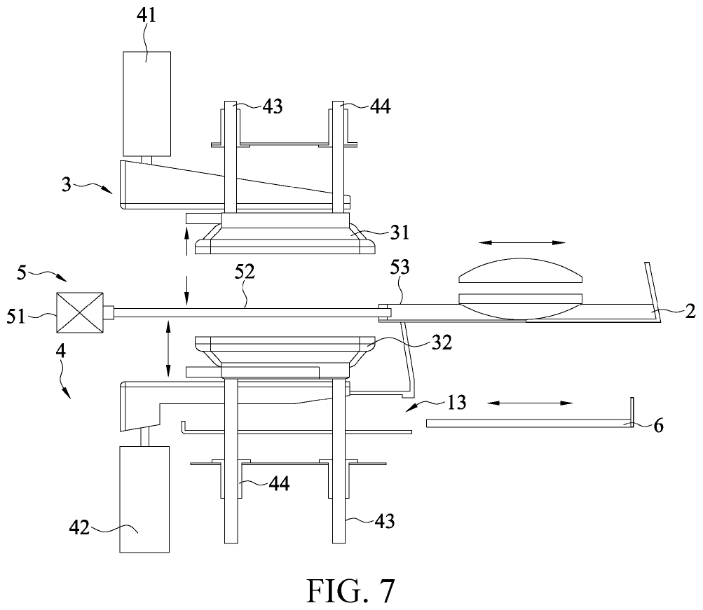

Referring to FIG. 1 to FIG. 4, and FIG. 7 to FIG. 9, in an embodiment, the first driving mechanism 4 includes an upper driving mechanism 41 and a lower driving mechanism 42. The upper driving mechanism 41 is configured to drive the hot-pressing upper mold 31, and the lower driving mechanism 42 is configured to drive the hot-pressing lower mold 32. The upper driving mechanism 41 and the lower driving mechanism 42 are screw transmission mechanisms, or the upper driving mechanism 41 and the lower driving mechanism 42 are push rods, such as pneumatic push rods or electric push rods. When the upper driving mechanism 41 and the lower driving mechanism 42 are push rods, a cylinder of the upper driving mechanism 41 is disposed on the body 1, and a telescopic rod of the upper driving mechanism 41 is in transmission connection with the hot-pressing upper mold 31. A cylinder of the lower driving mechanism 42 is disposed on the body 1, and the telescopic rod of the lower driving mechanism 42 is in transmission connection with the hot-pressing lower mold 32, so that the upper driving mechanism 41 and the lower driving mechanism 42 simultaneously drive the hot-pressing upper mold 31 and the hot-pressing lower mold 32 to be relatively closed or relatively separated. Through such arrangement, the first driving mechanism 4 has a simple structure, facilitating product manufacturing.

Referring to FIG. 7 to FIG. 9, in a further embodiment, a guide element is disposed between the hot-pressing upper mold 31 and the hot-pressing lower mold 32 and the body 1. Two groups or more of guide elements are disposed corresponding to each of the hot-pressing upper mold 31 and the hot-pressing lower mold 32. The guide element includes a guide post 43 vertically disposed in the body 1, and a guide sleeve 44 disposed on the hot-pressing upper mold 31 and the hot-pressing lower mold 32. The guide sleeve 44 can be slidably sleeved on the guide post. Through such arrangement, the hot-pressing upper mold 31 and the hot-pressing lower mold 32 enable the hot-pressing upper mold 31 and the hot-pressing lower mold 32 to move more smoothly and stably during relative mold closing and separation.

In a further embodiment, the guide element and the first driving mechanism 4 are respectively located on both sides of the hot-pressing upper mold 31 and the hot-pressing lower mold 32. Through such arrangement, verticality of the hot-pressing upper mold 31 and the hot-pressing lower mold 32 in opposite directions is better controlled to ensure a mold closing effect of the heating mechanism.

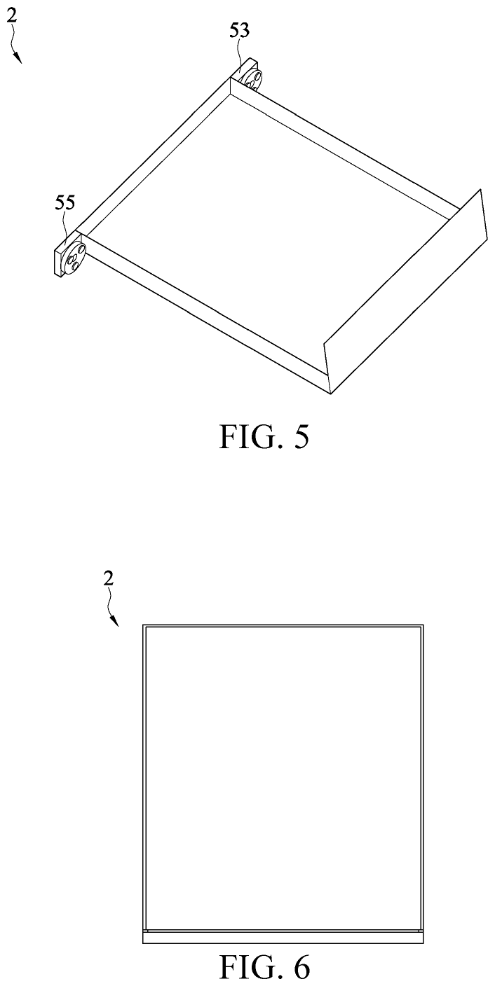

Referring to FIG. 2 and FIG. 5, in an embodiment, a second driving mechanism 5 is further included. The second driving mechanism 5 is configured to drive the tray 2 into the body 1 or exit through the inlet 12 to the outer side of the body 1. The second driving mechanism 5 is disposed on one side of the tray 2. The other side of the tray 2 is connected to the body 1 through a guide structure. The second driving mechanism 5 includes a second driving apparatus 51, a transmission screw 52, and a transmission nut 53. The second driving apparatus 51 is a motor in transmission connection with the driving screw 52, and the second driving apparatus 51 is preferably a servo motor. The servo motor has an advantage of high control accuracy, so that movement control accuracy of the tray 2 is high. The transmission screw 52 is in transmission connection with the transmission nut 53, and the tray 2 is connected to the transmission nut 53. The guide structure includes a guide rod 54 and a movable sleeve 55 arranged along a movement direction of the tray 2. The movable sleeve 55 is slidably sleeved on the guide rod 54. The other side of the tray 2 is connected to the movable sleeve 55. When the second driving apparatus 51 drives the transmission screw 52 to rotate, the tray 2 enters the body 1 or exits to the outer side of the body 1 along a direction of the guide rod 54. The tray 2 is driven by a screw rod, so that the tray 2 is moved stably. Through such arrangement, the tray 2 may automatically enter the body 1 or exit to the outer side of the body 1, so that the sandwich maker can realize fully automated work, reducing an amount of labor of the user, facilitating use.

Referring to FIG. 1 and FIG. 2, in a further embodiment, two inlets 12 are provided, two trays 2 are provided corresponding to the two inlets 12. Through such arrangement, the user may simultaneously perform hot pressing on a plurality of ingredients of the sandwich conveniently. Two second driving mechanisms 5 are disposed correspondingly. Through such arrangement, the user may simultaneously perform hot pressing on a plurality of ingredients of the sandwich conveniently.

Referring to FIG. 1 and FIG. 2, in an embodiment, a control module and a controller are further included. The control module is a control circuit board disposed on the body 1, and the controller is a console 8 disposed on the body 1. The console 8 is wired to the control module. In a solution that the tray 2 is electrically driven, the control module is electrically connected to the first driving mechanism 4 and the second driving mechanism 5 respectively. A working state of the hot-pressing mechanism 3 and the tray 2 may be controlled through the console 8.

In an embodiment (not shown), the control module and the controller are further included. The control module is a control circuit board disposed on the body 1, the controller is a remote control, and the controller is connected to the control module wirelessly, for example, through WiFi or Bluetooth. Alternatively, a receiver for receiving a signal sent by the remote controller is disposed on the control module. In a solution that the tray 2 is electrically driven, the control module is electrically connected to the first driving mechanism 4 and the second driving mechanism 5 respectively. A working state of the hot-pressing mechanism 3 and the tray 2 may be controlled through the remote control.

Referring to FIG. 7 to FIG. 9, during operation of the sandwich maker of the present invention, the user may control the second driving mechanism 5 through the console 8 to drive the tray 2 to move to the outer side of the body 1, and place the ingredients of the sandwich in the tray 2, and make the tray 2 with the ingredients of the sandwich enter the body 1. Then, the control module controls, through the first driving mechanism 4, the hot-pressing upper mold 31 and the hot-pressing lower mold 32 that have been preheated by the heating element 33 to close toward a side of the tray 2 to perform hot-pressing processing of the ingredients of the sandwich. After the ingredients of the sandwich completes hot pressing, the first driving mechanism 4 controls the hot-pressing upper mold 31 and the hot-pressing lower mold 32 to separate toward opposite directions, and the second driving mechanism 5 drives the tray 2 to move to the outer side of the body 1, so as to deliver a hot-pressed sandwich to the user.

Based on the disclosure and teachings of the foregoing specification, those skilled in the art to which the present invention belongs can further change and modify the foregoing implementation. Therefore, the present invention is not limited to the specific implementations disclosed and described above, and some modifications and changes to the present invention should also fall within the protection scope of the patent application for the present invention. In addition, although some specific terms are used in this specification, these terms are only for the convenience of description and do not constitute any limitation on the present invention.

What is claimed is:

1. A hot sandwich press, comprising:
a body, a tray, and a hot-pressing mechanism, wherein a front side of the body has an inlet in communication with an inside of the body, the tray may enter or exit the body through the inlet, the hot-pressing mechanism comprises a hot-pressing upper mold and a hot-pressing lower mold respectively located on an upper side and a lower side of the tray, and the hot-pressing upper mold and the hot-pressing lower mold may be relatively closed toward one side of the tray or reset toward an opposite direction; and further comprising a first driving mechanism and a material receiving structure, wherein the first driving mechanism is configured to drive the hot-pressing upper mold and the hot-pressing lower mold to be relatively closed or separated; and the material receiving structure is disposed on a front side of the body and located on a lower side of the tray, and is configured to catch residues of ingredients falling from the tray when the tray exits.

2. The sandwich maker according to claim 1, wherein the material receiving structure is a material receiving tray connected to the front side of the body.

3. The sandwich maker according to claim 2, further comprising a residue receiving tray disposed in the body and located on a lower side of the hot-pressing mechanism, wherein a guide opening is disposed on the body, and the residue receiving tray may enter the body or exit through the guide opening to an outer side of the body.

4. The sandwich maker according to claim 3, wherein the guide opening is disposed on the front side of the body and located on an upper side of the material receiving tray.

5. The sandwich maker according to claim 3, wherein a pull-out structure is disposed on an outer side of the residue receiving tray to facilitate pulling of the residue receiving tray to an outer side of the body, and the pull-out structure is a handle or a hook hole connected by using a tool.

6. The sandwich maker according to claim 1, further comprising a residue receiving tray disposed in the body and located on a lower side of the hot-pressing mechanism, wherein a guide opening is disposed on the body, and the residue receiving tray may enter the body or exit through the guide opening to an outer side of the body.

7. The sandwich maker according to claim 6, wherein the guide opening is disposed on the front side of the body and located on an upper side of the material receiving tray.

8. The sandwich maker according to claim 6, wherein a pull-out structure is disposed on an outer side of the residue receiving tray to facilitate pulling of the residue receiving tray to an outer side of the body, and the pull-out structure is a handle or a hook hole connected by using a tool.

9. The sandwich maker according to claim 1, further comprising a second driving mechanism, and the second driving mechanism is configured to drive the tray into the body or exit through the inlet to an outer side of the body.

10. The sandwich maker according to claim 1, wherein the tray is made of a thermally conductive material.

11. The sandwich maker according to claim 1, wherein the first driving mechanism comprises an upper driving mechanism and a lower driving mechanism, the upper driving mechanism is configured to drive the hot-pressing upper mold, the lower driving mechanism is configured to drive the hot-pressing lower mold, and the upper driving mechanism and the lower driving mechanism are one kind of screw transmission mechanisms, pneumatic push rods, or electric push rods.

12. The sandwich maker according to claim 1, wherein two inlets are provided, and two trays are provided corresponding to the two inlets.

13. The sandwich maker according to claim 9, wherein two inlets are provided, two trays are provided corresponding to the two inlets, and two second driving mechanisms are disposed correspondingly.
